(19) United States
(12) Patent Application Publication
(10) Pub. No.: US 2023/0243103 A1
(43) Pub. Date: Aug. 3, 2023

(54) NOVEL WATER-SOLUBLE POLYMER COMPLEXES IN THE FORM OF AN INVERSE EMULSION AND USES THEREOF

(71) Applicant: SPCM SA, ANDREZIEUX BOUTHEON (FR)

(72) Inventors: René HUND, ANDREZIEUX BOUTHEON (FR); Gatien FAUCHER, ANDREZIEUX BOUTHEON (FR); Damien FOUGEROUSE, ANDREZIEUX BOUTHEON (FR)

(73) Assignee: SPCM SA, ANDREZIEUX BOUTHEON (FR)

(21) Appl. No.: 17/906,693

(22) PCT Filed: Mar. 17, 2021
(86) PCT No.: PCT/FR2021/050442

§ 371 Date: Sep. 19, 2022

(30) Foreign Application Priority Data
Mar. 20, 2020 (FR) 2002772

(51) Int. Cl. D21H 17/00; D21H 17/56; D21H 17/43; D21H 17/45; D21H 21/10; D21H 23/04; D21H 11/14

(52) U.S. Cl. CPC D21H 17/72; D21H 17/56; D21H 17/43; D21H 17/455; D21H 21/10; D21H 23/04; D21H 11/14

(57) ABSTRACT

The present invention relates to a polymer complex obtained by inverse emulsion polymerization of water-soluble monomers: in the presence of a cationic water-soluble host polymer comprising amine functions.

### FIELD OF INVENTION

The present invention relates to a complex of water-soluble polymers derived from the inverse emulsion polymerization of one or more water-soluble monomers in the presence of a previously prepared polymer.

Another aspect of the invention relates to the use of this complex as a dewatering agent and, in particular, for its implementation in the manufacture of paper, cardboard or the like.

### PRIOR STATE OF THE ART

U.S. Pat. No. 9,546,246 from the applicant overcomes the problem of phase-shift between polymers. This patent discloses a polymer complex and its use as an agent for treating mineral fillers and, in particular, for its implementation in the manufacture of paper, cardboard or the like.

U.S. Pat. Nos. 7,001,953 and 8,021,516 disclose water-soluble polymers that can be used in sludge treatment and in papermaking. These polymers are obtained by polymerization of monomers in the presence of a previously and independently prepared polymer. As indicated in these documents, the polymer already synthesized and the polymer being synthesized do not substantially graft onto each other.

Document EP 262 945 A2 presents mixtures of cationic flocculants composed of two different polymers and their production processes. Agents are formed by polymerization of cationic monomers into a high molecular weight cationic polymer component (flocculant) in the presence of a low molecular weight cationic polymer component (coagulant). The properties of these flocculants do not meet the speed and efficiency requirements imposed by the technical flocculation processes.

Be that as it may, there is a demand for a polymer complex which is stable and satisfactory in terms of dewatering properties during implementation in the manufacture of paper, cardboard or the like.

### DISCLOSURE OF THE INVENTION

The present invention relates to a polymer complex comprising a cationic water-soluble polymer (host polymer) and one or more water-soluble monomers polymerized in the presence of said water-soluble host polymer.

The term “water-soluble” designates a compound (in particular a complex of polymers or a polymer or a monomer) forming an aqueous solution without insoluble particles when it is added under stirring for 4 hours at 25° C. at a concentration of 20 g·L⁻¹ in water.

More specifically, the object of the present invention relates to a polymer complex obtained by inverse emulsion polymerization of water-soluble monomers in the presence of one (or more) cationic water-soluble host polymer comprising amine functions.

The polymerization of water-soluble monomers corresponds to the polymerization of a single type of water-soluble monomer (for example, acrylamide) or of several types of water-soluble monomers (for example, acrylamide and ADAME quaternized with methyl chloride).

In the complex thus obtained, the polymer(s) resulting from the polymerization of the monomers branches out with the host polymer. It is not a mixture of polymers but a complex in which the host polymer acts as a transfer agent during the polymerization of the monomers.

The transfer agent, in this case the host polymer, makes it possible to control the length of the polymer chains formed during the polymerization of the water-soluble monomers.

The term “polymer” designates a homopolymer or a copolymer resulting from the polymerization of respectively identical or different monomers.

Another aspect of the invention is the use of this water-soluble polymer complex as a dewatering and turbidity reducing agent in the manufacture of paper, cardboard or the like.

### Host Polymer

The host polymer is advantageously a polyamine having ammonium groups and, advantageously, hydroxyl groups. It may also comprise secondary amine groups.

The host polymer is advantageously a polyamine selected from the group comprising poly-(dimethyl amine (co)epichlorohydrin) and poly(dimethylamine-co-epichlorohydrin-co-ethylenediamine). Preferably, the polyamine is a poly(dimethylamine-co-epichlorohydrin-co-ethylenediamine).

According to a variant of the invention, the host polymer may be a poly(epichlorohydrin-dimethylamine) generally comprising the repeating unit —[N⁺(CH₃)₂CH₂CHOHCH₂]Cl⁻¹—. Poly(epichlorohydrin-dimethylamine) may be obtained by the reaction between dimethylamine and epichlorohydrin, advantageously in a stoichiometric ratio.

According to another variant of the invention, the host polymer may be a poly(dimethylamine-co-epichlorohydrin-coethylenediamine). Polymers of this type may be obtained by reacting dimethylamine, ethylenediamine and epichlorohydrin.

According to a preferred characteristic of the invention, the host polymer is structured. In other words, it may advantageously have a branched, star or comb shape.

According to the invention, the host polymer has a molecular weight of at least 1000 g/mol, preferably at least 2000 g/mol, and, even more preferably, at least 5000 g/mol. In general, the molecular weight of the host polymer is preferably less than 2 million g/mol, more preferably less than 1 million g/mol.

### Complex of Water-Soluble Polymers

It is derived from the inverse emulsion polymerization of water-soluble monomers during which the pre-existing host polymer acts as a transfer agent. Thus, the present invention may be carried out in the absence of a non-polymeric transfer agent. Advantageously, the molecular weight of a non-polymeric transfer agent is less than 200 g/mol. The water-soluble monomer(s) used during the preparation of the complex of water-soluble polymers may, in particular, be at least one cationic monomer and/or at least one nonionic monomer and/or at least one anionic monomer. It may also be zwitterionic monomer(s). Preferably, the water-soluble monomers used during the preparation of the complex of water-soluble polymers are at least one cationic monomer and at least one nonionic monomer.

According to a preferred embodiment, the polymer complex is produced in the absence of water-insoluble monomers, in particular monomers of (meth)acrylate ester type.

The cationic monomer(s) that may be used in the context of the invention may advantageously be chosen from diallyldialkyl ammonium salts such as diallyl dimethyl ammonium chloride (DADMAC); acidified or quaternized salts of dialkylaminoalkyl acrylates and methacrylates, in particular dialkylaminoethyl acrylate (ADAME) and dialkylaminoethyl methacrylate (MADAME); acidified or quaternized salts of dialkyl-aminoalkylacrylamides or methacrylamides, such as, for example, methacrylamido-propyl trimethyl ammonium chloride (MAPTAC), acrylamido-propyl trimethyl ammonium chloride (APTAC) and Mannich products such as quaternized dialkylaminomethylacrylamides.

The “alkyl” groups of these monomers may be linear, cyclic (substituted or not) or branched. They may or may not be identical. Their number of carbon atoms is advantageously between 1 and 10, more advantageously between 1 and 8, even more advantageously between 1 and 4. It is preferably a methyl or ethyl group. Thus, the acidified or quaternized salts of ADAME and MADAME are advantageously the acidified or quaternized salts of dimethylaminoethyl acrylate and dimethylaminoethyl methacrylate.

The acidified salts are obtained by means known to a person skilled in the art, and, in particular, by protonation. The quaternized salts are also obtained by means known to a person skilled in the art, in particular by reaction with an alkyl halide, an aryl halide, for example benzyl chloride, methyl chloride (MeCI), aryl or alkyl chlorides, or dimethyl sulfate. The cationic monomer is advantageously ADAME quaternized with methyl chloride.

According to the invention, the proportion of cationic monomer used is advantageously between 1% mol and 80% mol, preferably between 2% mol and 60% mol, and, even more preferably, between 5% mol and 40% mol, relative to the total number of water-soluble monomers used. The nonionic monomer(s) that may be used in the context of the invention may be chosen from acrylamide, methacrylamide, N-isopropylacrylamide, N,N-dimethylacrylamide and N-methylolacrylamide. N-vinylformamide, N-vinyl acetamide, N-vinylpyridine and N-vinylpyrrolidone, acryloyl morpholine (ACMO) and diacetone acrylamide may also be used. A preferred nonionic monomer is acrylamide.

According to the invention, the proportion of nonionic monomer used is advantageously between 20 mol % and 99 mol %, preferably between 40 mol % and 98 mol %, and, even more preferably, between 60 mol % and 95 mol %, relative to the total number of water-soluble monomers used. The anionic monomer(s) that may be used in the context of the invention may be chosen from a large group. These monomers may have vinyl functionalities, in particular acrylic, maleic, fumaric, allylic and contain a carboxylate, phosphonate, phosphate, sulphate, sulphonate group, or another group with an anionic charge. The monomer may be acidic or else in the form of salt or alkaline earth metal, alkali metal or ammonium (advantageously quaternary ammonium) corresponding to such a monomer. Examples of suitable monomers include acrylic acid, methacrylic acid, itaconic acid, crotonic acid, maleic acid, fumaric acid and strong acid type monomers having, for example, a sulfonic or phosphonic acid type function such as 2-acrylamido 2-methylpropane sulfonic acid, vinylsulfonic acid, vinylphosphonic acid, allylsulfonic acid, allylphosphonic acid, styrenesulfonic acid, and the salts of these soluble monomers in water of an alkali metal, an alkaline earth metal, and ammonium. A preferred monomer is acrylic acid.

According to the invention, the proportion of anionic monomer used is advantageously between 0 mol % and 80 mol %, preferably between 1 mol % and 60 mol %, and, even more preferably, between 2 mol % and 40 mol %, relative to the total number of water-soluble monomers used.

The water-soluble monomers/host polymer mass ratio is preferably between 99/1 and 1/99, more preferably between 95/5 and 40/60.

Advantageously, the present invention uses at least two different types of water-soluble monomers, advantageously a nonionic monomer and a cationic monomer, more advantageously acrylamide and a cationic monomer (for example, ADAME quaternized with methyl chloride).

According to the invention, the polymer complex is advantageously obtained by inverse emulsion polymerization. Inverse emulsion polymerization also covers inverse microemulsion polymerization. This polymerization technique is well known to a person skilled in the art. It consists in emulsifying, in an oil phase, an aqueous phase containing the monomer(s). This emulsification is generally done using a water-in-oil surfactant. After polymerization of the monomer(s), an oil-in-water surfactant is optionally added to facilitate subsequent inversion of the emulsion in water.

At the end of the polymerization reaction, it is possible that the emulsion obtained is diluted or concentrated. In particular, it is possible to concentrate the emulsion, for example by distillation. Such a concentration will be carried out with or without the prior introduction of an emulsifying agent of the oil-in-water (O/W) type.

Advantageously, the process for preparing the polymer complex may comprise the following steps:
preparing an aqueous phase comprising at least one host polymer and water-soluble monomers;
emulsifying said aqueous solution in an oil phase;
obtaining the polymer complex by polymerization of the water-soluble monomers.

Preferably, during the preparation of the complex, the host polymer is introduced into the reactor with the monomers. The polymerization is then initiated by adding the catalysts.

Preferably, the polymerization is carried out in the absence of a branching agent or crosslinking agent of polyfunctional ethylenic type, for example in the absence of N,N-methylene-bis-acrylamide. It is advantageously carried out in the absence of a branching or crosslinking agent with a molecular weight of less than 200 g g/mol.

Another aspect of the invention is the use of the water-soluble polymer complexes in the manufacture of paper, cardboard or the like.

The process for the manufacture of paper, cardboard or the like, according to the invention may comprise the following steps, on a paper machine:
placing fibers, advantageously cellulosic fibers, in an aqueous suspension;
adding the polymer complex, object of the invention, in the aqueous suspension of fibers;
forming a sheet of paper, cardboard or the like on the wire surface of the paper machine;
drying the sheet.

The polymer complex may be added to the fiber suspension, at one or more injection points, in the dilute stock and/or in the thick stock.

In addition to the complex, other compounds known to a person skilled in the art may be combined.

Mention may be made, in a non-limiting manner, of dispersants, biocides or even antifoaming agents.

This process may also comprise the addition of polymers other than the complex according to the invention. Mention may be made, by way of example, of coagulants, retention agents, flocculants or even starch. These additives may be of polymeric or mineral nature, such as bentonite.

Thus, the process for the manufacture of paper, cardboard or the like may comprise the addition, before the formation of the sheet, of at least one additive, different from the polymer complex, chosen from coagulants, retention agents, flocculants and starch.

Preferably, the polymer complex is added into the thick stock before the mixing pump.

The various steps of the process for the manufacture of paper, cardboard or the like are in accordance with the techniques forming part of the knowledge of a person skilled in the art. The amount of complex added is advantageously between 3 g of active ingredient/ton of fibers (dry weight in fibers, advantageously cellulosic) and 10,000 g/T, preferably between 10 g/T and 7000 g/T and, even more preferably, between 30 g/T and 3000 g/T.

The use of polymer complexes is part of a general principle of improving product performance. Therefore, reducing the amount of product required for the application implicitly contributes to reducing greenhouse gas emissions such as CO2. In addition, the use of the polymer complex saves energy during the drying step of the sheet of paper, which requires less steam. The examples below illustrate the invention, although without limiting it.

### LIST OF FIGURES

FIG. 1 shows a graph of UL viscosity versus monomer/polyamine ratio.

FIG. 2 shows the percentage of improvement in thick stock dewatering and the turbidity measurement, compared to a reference test (blank).

FIG. 3 shows the percentage of improvement in vacuum dewatering in dilute stock and the turbidity measurement, compared to a reference test (blank).

FIG. 4 shows vacuum dewatering performance in dilute stock and turbidity measurement, compared to a reference test (blank).

FIG. 5 shows the dryness value before pressing, compared to a reference test (blank).

FIG. 6 shows the percentage of improvement in vacuum dewatering in dilute stock and the turbidity measurement, compared to a reference test (blank).

FIG. 7 shows vacuum dewatering performance in dilute stock and turbidity measurement, compared to a reference test (blank).

FIG. 8 shows the improvement (in percentage) of vacuum dewatering in dilute stock and the turbidity measurement, compared to a reference test (blank).

### EXAMPLES OF EMBODIMENTS OF THE INVENTION

In the following examples:
Polyamine H-1 is a structured poly-(dimethylamine/epichlorohydrin/ethylenediamine) with a Brookfield viscosity of 850 cps (Module LV2, 30 rpm⁻¹, 23° C.) at 50% of active ingredient by weight in water.
Polyamine H-2 is a linear poly-(dimethylamine/epichlorohydrin) with a Brookfield viscosity of 30 cps (Module LV1, 60 rpm⁻¹, 23° C.) at 50% of active ingredient by weight in water.
P-3: is a polymer in the form of an anionic inverse emulsion, linear poly-(acrylamide/acrylic acid), with a viscosity of UL=8.16 cps (Brookfield viscosity, Modulus UL, NaCl 1M, 60 rpm⁻¹, 23° C.) at 29% of active ingredient by weight in water.
P-4: is a polymer in cationic powder form, linear poly-(acrylamide/dimethylaminoethyl acrylate, MeCl), with a viscosity of UL=4.11 cps (Brookfield viscosity, Modulus UL, NaCl 1M, 60 rpm⁻¹, 23° C.) at 92% of active ingredient by weight in water.
Bentonite: Inorganic microparticle, marketed by Clariant under the name OPAZIL ABG.

### Synthesis of a Polymer in Inverse Emulsion P1

The aqueous phase is prepared by adding 359.8 g of acrylamide (50% solution by weight in water), 262.6 g of dimethylaminoethyl acrylate, MeCl (80% solution by weight in water) and 90.2 g of water. The pH of the solution is adjusted between 4 and 5 with adipic acid. Subsequently, 100-250 ppm/MS (mass in dry monomers) of potassium bromate and 800-1500 ppm/MS of sodium diethylenetriaminepentaacetate are added as initiators.

The organic phase is prepared by adding to a reactor 234.2 g of Exxsol D100S oil, 4.7 g of sorbitan monooleate, 8.2 g of sorbitan monooleate 3 EO (oxyethylene group), 11.1 g of sorbitan monooleate 5 EO (oxyethylene group) and 4.8 g of oil-in-water surfactant polymer (Rhodibloc RS).

The aqueous phase is then transferred to the organic phase and then emulsified, for example with Ultra-Turax, at 8000 rpm for 1 minute in order to obtain a uniform inverse emulsion.

The inverse emulsion is deoxygenated with a nitrogen sparge for 30 min. The polymerization is initiated by adding sodium bisulphite and the temperature is maintained at 55° C. for approximately 1.5 hours. The reaction medium is finally treated with an excess of sodium bisulphite to reduce the free monomers.

Once the inverse emulsion is completed, the Brookfield viscosity is measured (UL module, 1M NaCl 60 rpm⁻¹, 23° C.). A UL viscosity of 4.21 cps is obtained for an active ingredient of 39% by weight.

### Synthesis of the Polymer in Inverse Emulsion P2

The aqueous phase is prepared by adding 491.3 g of acrylamide (50% solution by weight in water), 92.9 g of dimethylaminoethyl acrylate, MeCl (80% solution by weight in water) and 149.2 g of water. The pH of the solution is adjusted between 4 and 5 with adipic acid. Subsequently, 100-250 ppm/MS potassium bromate and 800-1500 ppm/MS sodium diethylenetriaminepentaacetate are added as initiators.

The organic phase is prepared by adding 213.2 g of Exxsol D100S oil, 26 g of sorbitan monooleate and 3.8 g of surfactant polymer (Rhodibloc RS) to a reactor.

The aqueous phase is then transferred to the organic phase and then emulsified, for example with Ultra-Turax, at 8000 rpm for 1 minute in order to obtain a uniform inverse emulsion. The inverse emulsion is deoxygenated with a nitrogen sparge for 30 min. The polymerization is initiated by adding sodium bisulphite and the temperature is maintained at 55° C. for approximately 1.5 hours. The reaction medium is finally treated with an excess of sodium bisulphite to reduce the free monomers.

Once the inverse emulsion is completed, the Brookfield viscosity is measured (UL module, 1M NaCl 60 rpm⁻¹, 23° C.). A UL viscosity of 4.26 cps is obtained for an active ingredient of 32% by weight.

### Synthesis of a Complex in Inverse Emulsion According to the Invention (I-1)

The aqueous phase is prepared by adding 369.1 g of acrylamide (50% solution by weight in water), 256.8 g of dimethylaminoethyl acrylate, MeCl (80% solution by weight in water), 2.2 g of water and 82.5 g of polyamine H-1. The pH of the solution is adjusted between 4 and 5 with adipic acid. Subsequently, 100-250 ppm/MS potassium bromate and 800-1500 ppm/MS sodium diethylenetriaminepentaacetate are added as initiators.

The organic phase is prepared by adding to a reactor 234.2 g of Exxsol D100S oil, 4.7 g of sorbitan monooleate, 8.2 g of sorbitan monooleate 3 EO (oxyethylene group), 11.1 g of sorbitan monooleate 5 EO (oxyethylene group) and 4.8 g of surfactant polymer (Rhodibloc RS).

The aqueous phase is then transferred to the organic phase and then emulsified, for example with Ultra-Turax, at 8000 rpm for 1 minute in order to obtain a uniform inverse emulsion.

The inverse emulsion is deoxygenated with a nitrogen sparge for 30 min. The polymerization is initiated by adding sodium bisulphite and the temperature is maintained at 55° C. for approximately 1.5 hours. The reaction medium is finally treated with an excess of sodium bisulphite to reduce the free monomers.

Once the inverse emulsion is completed, the Brookfield viscosity is measured (UL module, 1M NaCl 60 rpm⁻¹, 23° C.). A UL viscosity of 3.81 cps is obtained for an active ingredient of 43.1% by weight.

### Synthesis of a Complex in Inverse Emulsion According to the Invention (I-2)

The aqueous phase is prepared by adding 290.6 g of acrylamide (50% solution by weight in water), 212.1 g of dimethylaminoethyl acrylate, MeCl (80% solution by weight in water), 1 g of water and 213.4 g of polyamine H-1. The pH of the solution is adjusted between 4 and 5 with adipic acid.

Subsequently, 100-250 ppm/MS potassium bromate and 800-1500 ppm/MS sodium diethylenetriaminepentaacetate are added as initiators.

The organic phase is prepared by adding to a reactor 234.2 g of Exxsol D100S oil, 4.7 g of sorbitan monooleate, 8.2 g of sorbitan monooleate 3 EO (oxyethylene group), 11.1 g of sorbitan monooleate 5 EO (oxyethylene group) and 4.8 g of surfactant polymer (Rhodibloc RS).

The aqueous phase is then transferred to the organic phase and then emulsified, for example with Ultra-Turax, at 8000 rpm for 1 minute in order to obtain a uniform inverse emulsion.

The inverse emulsion is deoxygenated with a nitrogen sparge for 30 min. The polymerization is initiated by adding sodium bisulphite and the temperature is maintained at 55 ° C. for approximately 1.5 hours. The reaction medium is finally treated with an excess of sodium bisulphite to reduce the free monomers.

Once the inverse emulsion is completed, the Brookfield viscosity is measured (UL module, 1M NaCl 60 rpm⁻¹, 23° C.). A UL viscosity of 3.71 cps is obtained for an active ingredient of 42.1% by weight.

### Synthesis of a Complex in Inverse Emulsion According to the Invention (I-3)

The aqueous phase is prepared by adding 287.8 g of acrylamide (50% solution by weight in water), 210.1 g of dimethylaminoethyl acrylate, MeCl (80% solution by weight in water), 0.7 g of water and 237.5 g of polyamine H-1. The pH of the solution is adjusted between 4 and 5 with adipic acid. Subsequently, 100-250 ppm/MS potassium bromate and 800-1500 ppm/MS sodium diethylenetriaminepentaacetate are added as initiators.

The organic phase is prepared by adding to a reactor 214.2 g of Exxsol D100S oil, 4.7 g of sorbitan monooleate, 8.2 g of sorbitan monooleate 3 EO (oxyethylene group), 11.1 g of sorbitan monooleate 5 EO (oxyethylene group) and 4.8 g of surfactant polymer (Rhodibloc RS).

The aqueous phase is then transferred to the organic phase and then emulsified, for example with Ultra-Turax, at 8000 rpm for 1 minute in order to obtain a uniform inverse emulsion.

The inverse emulsion is deoxygenated with a nitrogen sparge for 30 min. The polymerization is initiated by adding sodium bisulphite and the temperature is maintained at 55 ° C. for approximately 1.5 hours. The reaction medium is finally treated with an excess of sodium bisulphite to reduce the free monomers.

Once the inverse emulsion is completed, the Brookfield viscosity is measured (UL module, 1M NaCl 60 rpm⁻¹, 23° C.). A UL viscosity of 3.46 cps is obtained for an active ingredient of 43.1% by weight.

### Synthesis of a Complex in Inverse Emulsion According to the Invention (I-4)

The aqueous phase is prepared by adding 250.9 g of acrylamide (50% solution by weight in water), 183.1 g of dimethylaminoethyl acrylate, MeCl (80% solution by weight in water), 0.9 g of water and 280.1 g of polyamine H-1. The pH of the solution is adjusted between 4 and 5 with adipic acid. Subsequently, 100-250 ppm/MS potassium bromate and 800-1500 ppm/MS sodium diethylenetriaminepentaacetate are added as initiators.

The organic phase is prepared by adding to a reactor 234.2 g of Exxsol D100S oil, 4.7 g of sorbitan monooleate, 8.2 g of sorbitan monooleate 3 EO (oxyethylene group), 11.1 g of sorbitan monooleate 5 EO (oxyethylene group) and 4.8 g of surfactant polymer (Rhodibloc RS). The aqueous phase is then transferred to the organic phase and then emulsified, for example with Ultra-Turax, at 8000 rpm for 1 minute in order to obtain a uniform inverse emulsion.

The inverse emulsion is deoxygenated with a nitrogen sparge for 30 min. The polymerization is initiated by adding sodium bisulphite and the temperature is maintained at 55° C. for approximately 1.5 hours. The reaction medium is finally treated with an excess of sodium bisulphite to reduce the free monomers.

Once the inverse emulsion is completed, the Brookfield viscosity is measured (UL module, 1M NaCl 60 rpm⁻¹, 23° C.). A UL viscosity of 3.01 cps is obtained for an active ingredient of 41.2% by weight.

### Synthesis of a Complex in Inverse Emulsion According to the Invention (I-5)

The aqueous phase is prepared by adding 184.5 g of acrylamide (50% solution by weight in water), 134.7 g of dimethylaminoethyl acrylate, MeCl (80% solution by weight in water), 0.5 g of water and 396 g of polyamine H-1. The pH of the solution is adjusted between 4 and 5 with adipic acid. Subsequently, 100-250 ppm/MS potassium bromate and 800-1500 ppm/MS sodium diethylenetriaminepentaacetate are added as initiators.

The organic phase is prepared by adding to a reactor 234.2 g of Exxsol D100S oil, 4.7 g of sorbitan monooleate, 8.2 g of sorbitan monooleate 3 EO (oxyethylene group), 11.1 g of sorbitan monooleate 5 EO (oxyethylene group) and 4.8 g of surfactant polymer (Rhodibloc RS).

The aqueous phase is then transferred to the organic phase and then emulsified, for example with Ultra-Turax, at 8000 rpm for 1 minute in order to obtain a uniform inverse emulsion.

The inverse emulsion is deoxygenated with a nitrogen sparge for 30 min. The polymerization is initiated by adding sodium bisulphite and the temperature is maintained at 55° C. for approximately 1.5 hours. The reaction medium is finally treated with an excess of sodium bisulphite to reduce the free monomers.

Once the inverse emulsion is completed, the Brookfield viscosity is measured (UL module, 1M NaCl 60 rpm⁻¹, 23° C.). A UL viscosity of 2.51 cps is obtained for an active ingredient of 39.8% by weight.

### Synthesis of a Complex in Inverse Emulsion According to the Invention (I-6)

The aqueous phase is prepared by adding 439.1 g of acrylamide (50% solution by weight in water), 83.1 g of dimethylaminoethyl acrylate, MeCl (80% solution by weight in water), 0.2 g of water and 214 g of polyamine H-1. The pH of the solution is adjusted between 4 and 5 with adipic acid.

Subsequently, 100-250 ppm/MS potassium bromate and 800-1500 ppm/MS sodium diethylenetriaminepentaacetate are added as initiators.

The organic phase is prepared by adding 213.2 g of Exxsol D100S oil, 26 g of sorbitan monooleate and 3.8 g of surfactant polymer (Rhodibloc RS) to a reactor.

The aqueous phase is then transferred to the organic phase and then emulsified, for example with Ultra-Turax, at 8000 rpm for 1 minute in order to obtain a uniform inverse emulsion.

The inverse emulsion is deoxygenated with a nitrogen sparge for 30 min. The polymerization is initiated by adding sodium bisulphite and the temperature is maintained at 55° C. for approximately 1.5 hours. The reaction medium is finally treated with an excess of sodium bisulphite to reduce the free monomers.

Once the inverse emulsion is completed, the Brookfield viscosity is measured (UL module, 1M NaCl 60 rpm⁻¹, 23° C.). A UL viscosity of 3.61 cps is obtained for an active ingredient of 39.3% by weight.

### Synthesis of a Complex in Inverse Emulsion According to the Invention (I-7)

The aqueous phase is prepared by adding 287.8 g of acrylamide 50% by weight in water, 210.1 g of dimethylaminoethyl acrylate, MeCl 80% by weight in water, 0.7 g of water and 237.5 g of polyamine H-2. The pH of the solution is adjusted between 4 and 5 with adipic acid. Subsequently, 100-250 ppm/MS potassium bromate and 800-1500 ppm/MS sodium diethylenetriaminepentaacetate are added as initiators.

The organic phase is prepared by adding to a reactor 214.2 g of Exxsol D100S oil, 4.7 g of sorbitan monooleate, 8.2 g of sorbitan monooleate 3 EO (oxyethylene group), 11.1 g of sorbitan monooleate 5 EO (oxyethylene group) and 4.8 g of surfactant polymer (Rhodibloc RS).

The aqueous phase is then transferred to the organic phase and then emulsified, for example with Ultra-Turax, at 8000 rpm for 1 minute in order to obtain a uniform inverse emulsion.

The inverse emulsion is deoxygenated with a nitrogen sparge for 30 min. Polymerization is initiated by adding sodium bisulphite using a syringe pump. The temperature is raised to then maintained at 55° C. for approximately 1.5 hours. The reaction medium is finally treated with an excess of sodium bisulphite to reduce the free monomers.

Once the inverse emulsion is completed, the Brookfield viscosity is measured (UL module, 1M NaCl 60 rpm⁻¹, 23° C.). A UL viscosity of 3.31 cps is obtained for an active ingredient of 43.1% by weight.

### Synthesis of a Complex in Inverse Emulsion According to the Invention (I-8)

The aqueous phase is prepared by adding 537.3 g of acrylamide 50% by weight in water, 101.7 g of dimethylaminoethyl acrylate, MeCl 80% by weight in water, 0.7 g of water and 73 g of polyamine H-1. The pH of the solution is adjusted between 4 and 5 with adipic acid. Subsequently, 100-250 ppm/MS potassium bromate and 800-1500 ppm/MS sodium diethylenetriaminepentaacetate are added as initiators.

The organic phase is prepared by adding 210.3 g of Exxsol D100S oil, 25.9 g of sorbitan monooleate and 3.7 g of surfactant polymer (Rhodibloc RS) to a reactor.

The aqueous phase is then transferred to the organic phase and then emulsified, for example with Ultra-Turax, at 8000 rpm for 1 minute in order to obtain a uniform inverse emulsion.

The inverse emulsion is deoxygenated with a nitrogen sparge for 30 min. Polymerization is initiated by adding sodium bisulphite using a syringe pump. The temperature is raised to then maintained at 55° C. for approximately 1.5 hours. The reaction medium is finally treated with an excess of sodium bisulphite to reduce the free monomers.

Once the inverse emulsion is completed, the Brookfield viscosity is measured (UL module, 1M NaCl 60 rpm⁻¹, 23° C.). A UL viscosity of 4.01 cps is obtained for an active ingredient of 38.6% by weight.

### Synthesis of a Complex in Inverse Emulsion According to the Invention (I-9)

The aqueous phase is prepared by adding 280.5 g of acrylamide (50% solution by weight in water), 204.7 g of dimethylaminoethyl acrylate, MeCl (80% solution by weight in water), 0.7 g of water and 227.5 g of polyamine H-1. The pH of the solution is adjusted between 4 and 5 with adipic acid. 2-25 ppm/MS of sodium hypophosphite is added as a limiting agent as well as 2-25 ppm/MS of methylene bis acrylamide as a cross-linking agent. Subsequently, 100-250 ppm/MS potassium bromate and 800-1500 ppm/MS sodium diethylenetriaminepentaacetate are added as initiators.

The organic phase is prepared by adding to a reactor 211.2 g of Exxsol D100S oil, 4.7 g of sorbitan monooleate, 8.2 g of sorbitan monooleate 3 EO (oxyethylene group), 11.1 g of sorbitan monooleate 5 EO (oxyethylene group) and 4.8 g of surfactant polymer (Rhodibloc RS).

The aqueous phase is then transferred to the organic phase and then emulsified with Ultra-Turax at 8000 rpm for 1 minute in order to obtain a uniform inverse emulsion.

The inverse emulsion is deoxygenated with a nitrogen sparge for 30 min. The polymerization is initiated by adding sodium bisulphite and the temperature is maintained at 55° C. for approximately 1.5 hours. The reaction medium is finally treated with an excess of sodium bisulphite to reduce the free monomers.

Once the inverse emulsion is completed, the Brookfield viscosity is measured (UL module, 1M NaCl 60 rpm⁻¹, 23° C. ). A UL viscosity of 2.31 cps is obtained for an active ingredient of 41.8%.

Concerning the stability of the inverse emulsions according to the invention (I-1 to I-9), we do not observe any phase-shift after several weeks of storage at room temperature.

### Synthesis of a Mixture of Polymers in Inverse Emulsion (M-1)

In a 1L beaker, 767.8 g of the P2 emulsion are weighed and stirred using a half-moon type stirring blade. 205.2 g of polyamine H-1 are added slowly, then the mixture is left stirring for 10 min. to ensure its homogeneity. The mixture has an active ingredient of 35.8% by weight. A phase-shift of the mixture is observed after one week of storage at ambient temperature.

### Synthesis of a Mixture of Polymers in Inverse Emulsion (M-2)

In a 1L beaker, 571.8 g of emulsion P1 are weighed and stirred using a half-moon type stirring blade. 300 g of polyamine H-1 are added slowly, then the mixture is left stirring for 10 min. to ensure its homogeneity. The mixture has an active ingredient of 38.2% by weight. A phase-shift of the mixture is observed after one week of storage at ambient temperature.

### Synthesis of a Mixture of Polymers in Inverse Emulsion (M-3)

In a 1 L beaker, 759.9 g of the P2 emulsion are weighed and stirred using a half-moon type stirring blade. 54 g of polyamine H-1 are added slowly then the mixture is left stirring for 10 min. to ensure its homogeneity. The mixture has an active ingredient of 33.2% by weight. A phase-shift of the mixture is observed after one week of storage at room temperature.

### Synthesis of a Polymer in Powder Form (C-1)

In a polymerization reactor, 748.7 g of 50% acrylamide, 126.2 g of dimethylaminoethyl acrylate, 80% MeCl, 431.5 g of water and 95 g of polyamine H-1 are charged. The pH of the solution is adjusted between 3 and 4 with adipic acid. The solution is cooled to a temperature between 0 and 2° C., then deoxygenated with nitrogen sparge for 15 min. Subsequently, 1-15 ppm/MS of sodium persulfate and 1-15 ppm/MS of Mohr's salt are added as initiators.

The reaction temperature increases from 0 to 90° C. and the polymer is obtained in the form of a gel. This gel is cut, chopped, dried for 45 min. at a temperature of 75° C., ground and finally sieved. A polymer is thus obtained in powder form with a particle size less than or equal to 1 mm. Once the polymer in powder form is completed, the Brookfield viscosity is measured (UL module, 1M NaCl 60 rpm⁻¹, 23° C.). A UL viscosity of 3.76 cps is obtained for an active ingredient of 92.8% by weight in water.

TABLE 1
summary of examples and counter-examples (PA = polyamine,
MA % = percentage of active ingredient by weight)

| | | Cationic | | Monomers/ | | |
|---|---|---|---|---|---|---|
| | | monomer | PA | polyamine | | UL |
| Name | Form | (% mol) | type | % by weight | MA % | (cps) |
| P-1 | Emulsion | 30 | NA | 100/0 | 39 | 4.21 |
| P-2 | Emulsion | 10 | NA | 100/0 | 32 | 4.26 |
| H-l | Liquid | NA | H-l | 0/100 | 50 | NA |
| H-2 | Liquid | NA | H-2 | 0/100 | 50 | NA |
| I-1 | Emulsion | 30 | H-1 | 90/10 | 43 | 3.81 |
| I-2 | Emulsion | 30 | H-1 | 75/25 | 42 | 3.71 |
| I-3 | Emulsion | 30 | H-1 | 70/30 | 43 | 3.46 |
| I-4 | Emulsion | 30 | H-1 | 66/34 | 41 | 3.01 |
| I-5 | Emulsion | 30 | H-1 | 50/50 | 40 | 2.51 |
| I-6 | Emulsion | 10 | H-1 | 70/30 | 39 | 3.61 |
| I-7 | Emulsion | 30 | H-2 | 70/30 | 43 | 3.31 |
| I-8 | Emulsion | 10 | H-1 | 90/10 | 39 | 4.01 |
| I-9 | Emulsion | 30 | H-1 | 70/30 | 42 | 2.31 |
| M-1 | Mixed | 10 | H-1 | 70/30 | 36 | 4.26 |
| M-2 | Mixed | 30 | H-1 | 70/30 | 38 | 4.21 |
| M-3 | Mixed | 10 | H-1 | 90/10 | 33 | 4.26 |
| C-1 | Powder | 10 | H-1 | 90/10 | 93 | 3.76 |
| P-3 | Emulsions | 30* | NA | 100/0 | 29 | 8.16 |
| P-4 | Powder | 10 | NA | 100/0 | 92 | 4.11 |

*molar percentage of anionic monomer

TABLE 2
Summary of sequences for evaluations of polymer combinations

| Test | Sequences | | |
|---|---|---|---|
| No. | 5 seconds | 10 seconds | 20 seconds |
| 1 | Blank | | |
| 2 | | P-4 | |
| 3 | P-2 | P-4 | |
| 4 | I-6 | P-4 | |
| 5 | P-1 | P-4 | |
| 6 | I-3 | P-4 | |
| 7 | | P-4 | Bentonite |
| 8 | P-1 | P-4 | Bentonite |
| 9 | I-3 | P-4 | Bentonite |
| 10 | | P-4 | Bentonite |
| | | | P-3 |
| 11 | P-1 | P-4 | Bentonite |
| | | | P-3 |
| 12 | I-3 | P-4 | Bentonite |
| | | | P-3 |
| 13 | | P-4 | P-3 |
| 14 | P-1 | P-4 | P-3 |
| 15 | I-3 | P-4 | P-3 |

The tests in Table 2 are analyzed by group: [2-4], [5-6], [7-8-9], [10-11-12], and [13-14-15].

### Evaluation Test Procedures

### Recycled Fiber Stock

The wet stock is obtained by disintegration of dry stock in order to obtain a final aqueous concentration of 4% by weight in water to produce the thick stock, which is diluted in water at 1% by weight to obtain the dilute stock. It is a pH-neutral stock made from 100% recycled cardboard fibers.

### UL Viscosity Measurement

500 mg of polymer (derived from the polymerization of the monomers, according to the invention or not) are added to 490 ml of deionized water. After complete dissolution, 29.25 grams of NaCl are added.

The viscosity is measured using a digital Brookfield DVII+ viscometer at a rotational speed of 60 rpm at 25° C. (UL module).

### Evaluation of the Dewatering Performance (DDA)

The DDA (Dynamic Drainage Analyzer) is used to automatically determine the time (in seconds) required to drain a fibrous suspension under vacuum. The polymers are added to the wet stock (0.6 liter of stock at 1.0% by weight) in the DDA cylinder under stirring at 1000 rpm:
According to the following sequence for the evaluation of a single polymer:

T=0 sec: stirring the stock

T=10 sec: adding the cationic dewatering agent (350 g/t)

T=30 sec: stirring stopped and dewatering under vacuum at 200 mBar for 60 sec
According to the following sequence for the evaluation of a combination of polymers:

T=0 sec: stirring the dough

T=5 sec: adding the cationic dewatering agent (350 g/t)

T=10 sec: adding the cationic polymer (250 g/t)

T=20 sec: adding the anionic polymer (150 g/t) and/or the bentonite (1.5 kg/t)

T=30 sec: stirring stopped and dewatering under vacuum at 200 mBar for 60 sec

The dosages are expressed in grams of active ingredient/ton of fibers (dry weight in fibers, advantageously cellulosic).

The pressure under the wire surface is recorded as a function of time. When all the water is evacuated from the fibrous pad, the air passes through it, causing a break in the slope to appear on the curve, representing the pressure under the wire surface as a function of time. The time, expressed in seconds, recorded at this break in slope, corresponds to the dewatering time. The shorter the time, the better the vacuum dewatering.

In addition, the turbidity of the white water resulting from the DDA measurement is measured. The lower the turbidity value, the greater the retention of solid particles in the fibrous pad.

### Dryness

The DDA test allows free water to be drained from the fibrous suspension under vacuum. The purpose of the dryness test is to measure the amount of water bound in the fibrous pad. To that end, the cake of fibrous pad obtained from the DDA test is recovered and its mass is measured before and after drying in an oven at 105° C. for 2 hours. The ratio of the two masses gives the dryness. The higher this value, the more the dewatering polymer removes bound water.

### Evaluation of the Dewatering Performance in Thick Stock

In a beaker, 500 ml of thick stock at 4% in water is treated, subjected to a low shear rate (stirring speed of 300 rpm). The polymer is added to this fibrous suspension with a contact time T=1 min.

This treated stock is transferred to the Canadian Standard Freeness Tester.

The volume of water released over time is recorded. The more water released, the better the dewatering of the thick stock.

### Turbidity

Turbidity refers to the content of suspended matter that clouds the fluid. It is measured using a HANNA spectrophotometer, which measures the decrease in the intensity of the light ray at a 90° angle and at an 860 nm wavelength, expressed in NTU.

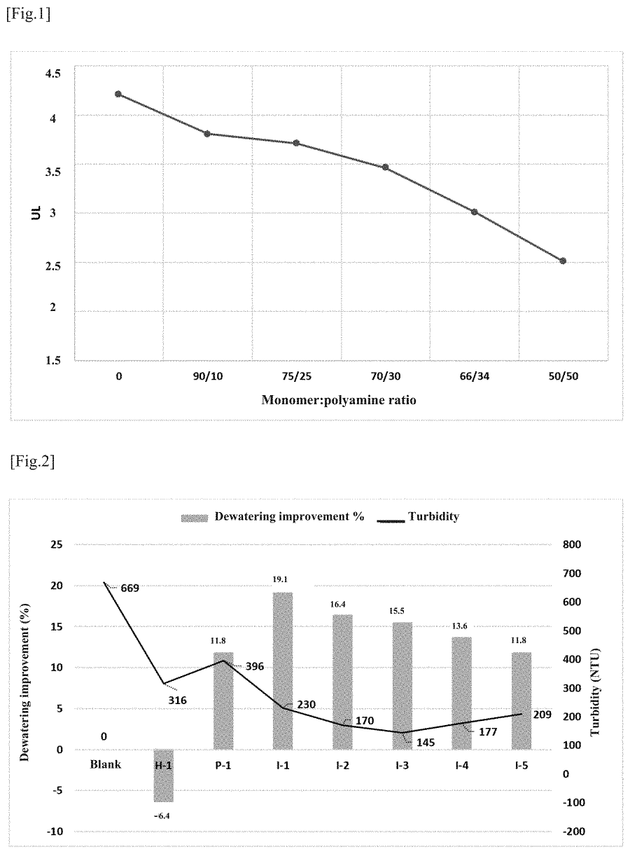

FIG. 1 demonstrates that, all things being otherwise equal, the UL viscosity drops when the monomer/polyamine ratio drops. This leads to the conclusion that the polyamine acts as a transfer agent to the polymer.

FIGS. 2 and 3 demonstrate that, whatever the products of the invention (I-1 to I-5) with respect to the polymer alone (P-1) and with respect to the polyamine alone (H-1), there is a synergistic effect between the improvement in thick stock dewatering, vacuum dewatering of dilute stock (DDA) as well as turbidity. In this case, the monomer/polyamine mass ratio of 70/30 (I-3) makes it possible to obtain the most favorable combination of gain in thick stock dewatering/vacuum dewatering of the dilute stock (DDA)/turbidity.

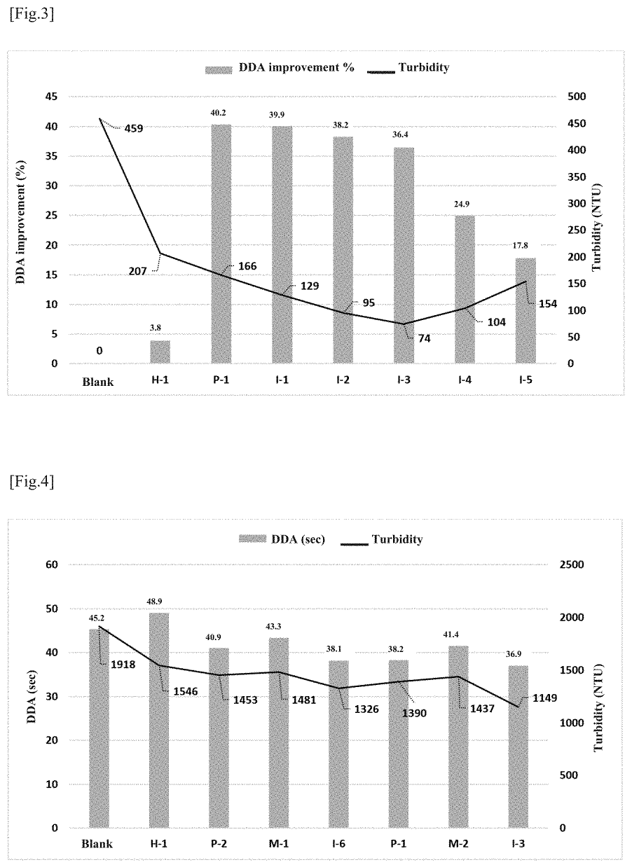

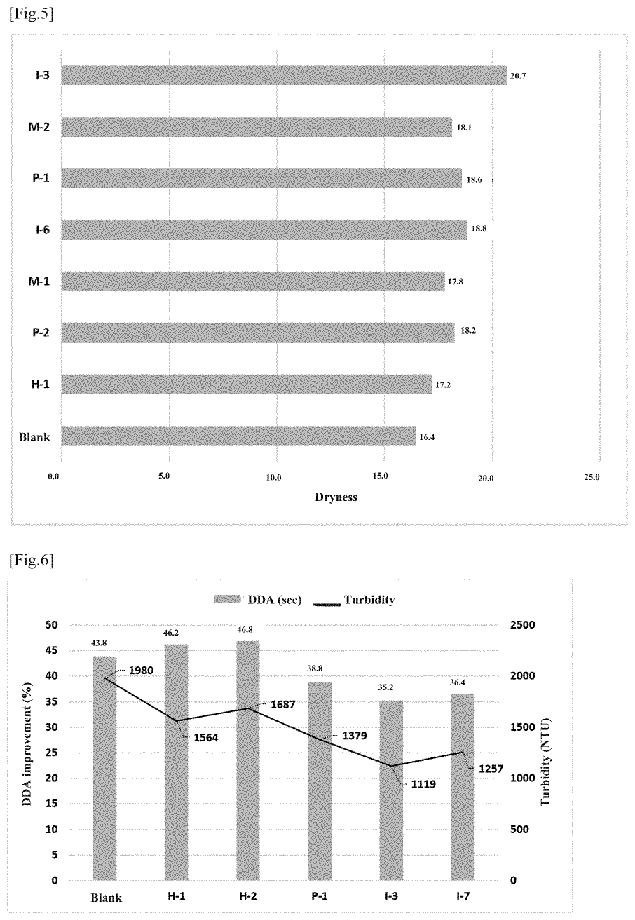

FIGS. 4 and 5 demonstrate that the products of the invention (I-3 and I-6) are much more efficient in vacuum dewatering of the dilute stock, in turbidity, as well as in dryness before press compared to the corresponding mixtures (M-1 and M-2) and to the products alone (H-1, P-1 and P-2).

FIG. 6 demonstrates that, whatever the products of the invention (I-3 and I-7) compared to the products alone (P-1, H-1, H-2), there is a synergistic effect between the improvement in vacuum dewatering of the dilute stock (DDA) as well as turbidity. In this specific case, it should be noted that the structure of the polyamine has a positive impact on the application performance compared to a linear polyamine.

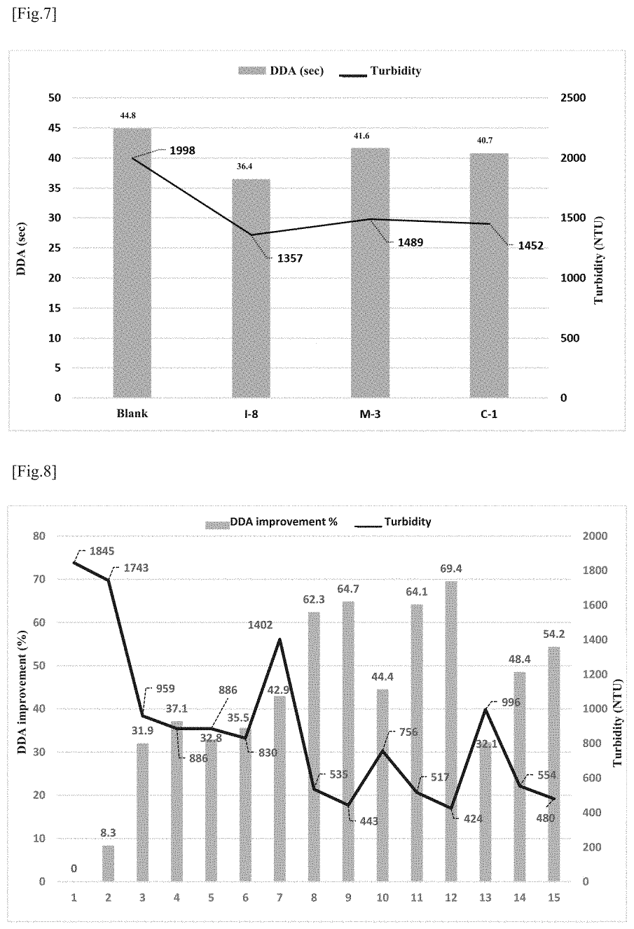

FIG. 7 demonstrates that polymerization in the form of an inverse emulsion (I-8) remains much more efficient compared to the corresponding powder form (C-1) and mixture (M-3). In addition, polymerization in inverse emulsion form, with a polyamine, makes it possible to solve the stability problem of the simple mixture.

According to FIG. 8, in tests 2 to 15, the products of the invention I-3 and I-6, tested in comparison and respectively with the products P-1 and P-2 (Table 2; Test 4 vs 2 and 3, Test 6 vs 2 and 5, Test 9 vs 7 and 8, Test 12 vs 10 and 11, and Test 15 vs 13 and 14), in combination with a retention system (single or multi-component), provide better performance in terms of improved dilute stock vacuum dewatering (DDA) as well as reduced turbidity.

1. A polymer complex obtained by inverse emulsion polymerization of water-soluble monomers: in the presence of a cationic water-soluble host polymer comprising amine functions.

2. The polymer complex according to claim 1, wherein the host polymer is chosen from poly-(dimethylamine (co)epichlorohydrin) and poly(dimethylamine-co-epichlorohydrin-co-ethylenediamine).

3. The polymer complex according to claim 1, wherein the host polymer is poly(dimethylamine-co-epichlorohydrin-co-ethylenediamine).

4. The polymer complex according to claim 1, wherein the mass ratio between the water-soluble monomers and the host polymer is between 99/1 and 1/99.

5. The polymer complex according to claim 1, wherein the water-soluble monomers are chosen from the group consisting of:
quaternary ammonium salts of dimethylaminoethyl acrylate (ADAME); quaternary ammonium salts of dimethylaminoethyl methacrylate (MADAME); dimethyldiallylammonium chloride (DADMAC); acrylamido propyltrimethyl ammonium chloride (APTAC); methacrylamido propyltrimethyl ammonium chloride (MAPTAC);
acrylamide; N-isopropylacrylamide; N,N-dimethylacrylamide; N-vinylformamide; N-vinylpyrrolidone;
acrylic acid; methacrylic acid; itaconic acid; crotonic acid; maleic acid; fumaric acid; 2-acrylamide 2-methylpropane sulfonic acid; vinylsulfonic acid; vinyl phosphoric acid; allylsulfonic acid; allylphosphonic acid; styrene sulfonic acid; water-soluble alkali metal, alkaline earth metal, or ammonium salts of these monomers.

6. A process for preparing the polymer complex according to claims 1, comprising the following steps:
preparing an aqueous phase comprising at least one host polymer and water-soluble monomers;
emulsifying said aqueous solution in an oil phase; and
obtaining the polymer complex by polymerization of the water-soluble monomers.

7. The process according to claim 6, wherein the polymerization is carried out in the absence of a branching agent or crosslinking agent of polyfunctional ethylenic type.

8. A process for the manufacture of a sheet of paper, cardboard or the like, wherein, before forming said sheet, a polymer complex according to claim 1 is added to a suspension of fibers at one or more injection points.

9. The process according to claim 8, wherein the amount of polymer complex added is, by dry weight, between 3 g/ton of fibers and 10,000 g/ton of fibers.

10. A process for the manufacture of paper, cardboard or the like, comprising the following steps, on a paper machine:
placine fibers in an aqueous suspension;
adding the polymer complex according to claim 1;
forming a sheet of paper, cardboard or the like on the wire surface of the paper machine; and
drying the sheet.

11. The process for the manufacture of paper, cardboard or the like, according to claim 10, wherein the process comprises adding, before said forming the sheet of paper, at least one additive, different from the polymer complex, chosen from coagulants, retention agents, flocculants and starch.

12. The polymer complex according to claim 2, wherein the mass ratio between the water-soluble monomers and the host polymer is between 99/1 and 1/99.

13. The polymer complex according to claim 12. wherein the mass ratio between the water-soluble monomers and the host polymer is between 95/5 and 40/60.

14. The polymer complex according to claim 3, wherein the mass ratio between the water-soluble monomers and the host polymer is between 99/1 and 1/99.

15. The polymer complex according to claim 14, wherein the mass ratio between the water-soluble monomers and the host polymer is between 95/5 and 40/60.

16. The polymer complex according to claim 4, wherein the mass ratio between the water-soluble monomers and the host polymer is between 95/5 and 40/60.

17. The process according to claim 9, wherein the amount of polymer complex added is, by dry weight, between 10 g/ton of fibers and 7000 g/ton of fibers.

18. The process according to claim 9, wherein the amount of polymer complex added is, by dry weight, between 30 g/ton of fibers and 3000 g/ton of fibers.

19. The process according to claim 9, wherein fibers are cellulosic fibers.

20. The process according to claim 10, wherein fibers are cellulosic fibers.
